(19) United States
(12) Patent Application Publication
(10) Pub. No.: US 2018/0134932 A1
(43) Pub. Date: May 17, 2018

(54) ONE PART MOISTURE CURABLE ADHESIVES

(71) Applicant: Dow Global Technologies LLC, Midland, MI (US)

(72) Inventors: Sarah E. House, Lake Jackson, TX (US); Bhawesh Kumar, Lake Jackson, TX (US); Gray L. Jialanella, Oxford, MI (US)

(21) Appl. No.: 15/579,343

(22) PCT Filed: Jun. 22, 2016
(86) PCT No.: PCT/US16/38634

§ 371 Date: Dec. 4, 2017

Related U.S. Application Data
(60) Provisional application No. 62/184,543, filed on Jun. 25, 2015.

(51) Int. Cl. C09J 175/08; C09J 5/00; C08G 18/10; C08G 18/48; C08G 18/50; C09J 11/06

(52) U.S. Cl. CPC C09J 175/08; C09J 5/00; C08G 18/10; C08K 5/549; C08G 18/48; C08G 18/5096; C09J 11/06; C08G 18/4833

(57) ABSTRACT

An improved one part moisture curable composition is comprised of an isocyanate functional prepolymer, a cyclic silane, a filler and a catalyst. The adhesive composition is particularly useful for adhering sag bent and press bent glasses having fits applied to the periphery of the glass such as used in vehicle windshields.

### FIELD OF INVENTION

This invention relates to one part moisture curable polyurethane adhesives. In particular, the moisture curable polyurethane adhesives are useful for bonding automotive glass to vehicles without a primer to aid bonding to the glass.

### BACKGROUND OF INVENTION

One-component moisture curable polyurethane (PU) adhesives have been used in automotive glass bonding for more than 40 years such as described by Rizk, U.S. Pat. No. 4,780,520; Bhat, U.S. Pat. No. 5,976,305; Hsieh et al, U.S. Pat. No. 6,015,475 and Zhou, U.S. Pat. No. 6,709,539. Typically, PU adhesives are used in conjunction with primers to facilitate bonding between the adhesive and both the automotive glass and the painted car body. Primerless-to-paint PU adhesives have been developed by employing silanated prepolymers in the PU adhesive that assist in bonding to the paint. However, primerless-to-glass adhesion has remained a challenge particularly for press bent glasses.

Glass frits can be divided into two main categories based on the process to make automotive window glass: sag bent and press bent frits. In the sag bending process a flat piece of glass is placed atop a mold and heated to the viscoelastic phase, in which it is sufficiently malleable to allow deformation into the desired shape under the action of gravity. In the press bending process, glass sheets are heated and then pressed into a mold using a pressing ram coated with refractory fibers (metal or higher melting fiber glass). The fiber aids release of the bent glass frit from the pressing ram.

In both processes, an inorganic frit composed of differing oxides particulates are deposited on the periphery of the window. During the bending process the fits fuse and melt forming a black band around the window. The band is for decorative and UV protection of the adhesive used to bond it to the vehicle. The sag bend frits generally are amorphous and smoother than press bent frits. Press bent frits commonly are seeded with crystallization nucleation agents that cause the frit to at least in part crystallize after fusing to aid, for example in reducing or eliminating sticking of the pressing ram. In contrast, sag bent frits are almost always amorphous. Because press bent frits have been formulated to eliminate sticking of the pressing ram, press bent glass is and has been more difficult to bond into a vehicle.

It would be desirable to provide a one part moisture curable adhesive that addresses one or more of the above challenges and in particular improves the adhesion of a PU adhesive to a press bent window, particularly without the use of a primer.

### SUMMARY OF INVENTION

A first aspect of the invention is a one part moisture curable adhesive composition comprising, (a) an isocyanate functional prepolymer, (b) a cyclic silane, (c) a filler and (d) a catalyst.

A second aspect of the invention is a method of bonding at least two substrates together comprising;
(i) delivering the adhesive composition of the first aspect to an application nozzle,
(ii) applying a bead of the adhesive composition from step (i) through the application nozzle on to at least a portion of at least one of the substrates,
(iii) contacting the substrates to be bonded and
(iv) allowing the adhesive composition to cure.

The second aspect of the invention is surprisingly useful when one of the substrates is a press bent glass having a press bent frit on the periphery where the adhesive is applied.

A variety of substrates may be bonded together using the adhesive composition for instance, plastics, glass, wood, ceramics, metal, coated substrates, such as plastics with an abrasion resistant coating disposed thereon, and the like. The compositions of the invention may be used to bond similar and dissimilar substrates together. The compositions are especially useful for bonding glass or a plastic with an abrasion resistant coating disposed thereon to other substrates such as vehicles and buildings. The compositions of the invention are also useful in bonding parts of modular components together, such as vehicle modular components. In particular, the compositions are useful to bond automotive window glass having a press bent frit to an automobile.

The adhesive demonstrates rapid strength development which facilitates rapid drive away times of preferably one hour, and more preferably 30 minutes, after application of the adhesive at temperatures of from about 0° F. (−18° C.) to about 115° F. (46° C.). In particular, windshields installed under such conditions meet United States Federal Motor Vehicle Safety Standard (FMVSS) 212. In some preferred embodiments, the compositions of the invention are nonconductive and demonstrate a dielectric constant of about 15 or less. The compositions of the invention typically demonstrate a modulus after application for two weeks of about 1 MPa or greater, more preferably about 2 MPa or greater and preferably about 4 MPa or less according to ASTM D4065 measured at 25° C. This modulus is desirable because it allows for a compliant enough adhesive to absorb the vibrations and shock experienced by a windshield in an automobile and still has the strength to adhere the windshield in the automobile.

### DETAILED DESCRIPTION OF INVENTION

The adhesive composition is comprised of a cyclic silane, isocyanate functional prepolymer, filler and a catalyst. The cyclic silane is a compound with a 3 to 8 membered ring without pi conjugated bonding (i.e., not aryl) wherein a Si is adjacent to a heteroatom (e.g., O, N, or S) in the ring and the Si has at least one hydrolyzable group pendant (e.g., aryloxy or alkyloxy) to it. The cyclic silane upon ring opening between the silicon and heteroatom forms an active hydrogen pendant from the heteroatom that is reactive with an isocyanate group. The ring may contain more than one heteroatom and the members of the ring may have pendant groups that are heteroatoms or hydrocarbon moieties such as C₁-C₁₂ alkyl or H. Preferably, such pendant groups are H or C₁-C₃ alkyl. Formation of cyclic silane groups are known and are described for example in U.S. Pat. Nos. 3,146,250; 3,215,718; 3,417,121; 4,839,453 each being incorporated herein by reference.

Desirably the cyclic silane has the following general structure:

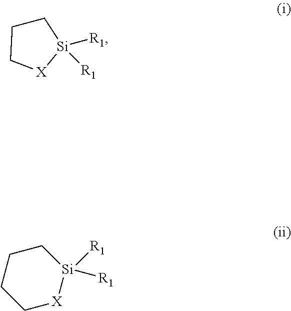

or mixture of (i) and (ii),
where X is a O, S, or N—R₂, where R₂ is a C₁-C₁₂ alkyl, alkylaryl or aryl, and R₁ is independently C₁-C₁₂ alkyl, C₁-C₁₂ alkoxy or C₁-C₁₂ acyloxy so long at least one R₁ is C₁-C₁₂ alkoxy or C₁-C₁₂ acyloxy. Desirably, each R₁ is: C₁-C₁₂ alkoxy or C₁-C₁₂ acyloxy; more desirably, each R₁ is C₁-C₁₂ alkoxy; and, most desirably, each R₁ is C₁-C₃ alkoxy. Desirably, each X is S or N—R₂. R₂ is preferably C₁-C₁₂ alkyl. The adhesive composition desirably is comprised of the cyclic silane (i). Desirably, X is S, N—R₂ and each R₁ is C₁-C₁₂ alkoxy or C₁-C₃ alkoxy. More desirably, X is N—R₂ and each R₁ is C₁-C₁₂ alkoxy or C₁-C₃ alkoxy. Exemplary compounds include dimethoxythiosilacyclopentane (DTSCP) and (N-butyl) aminodimethoxysilacyclopentane (N-Bu-ADSCP) and are available from Sigma Aldrich, St Louis, Mo.

The cyclic silane is typically present in an amount of about 0.01 parts by weight of the adhesive composition or greater, more preferably about 0.1 parts by weight or greater and most preferably about 1 parts by weight or greater. Preferably, the cyclic silanes are present in an amount of about 5 parts by weight of the adhesive composition or less, more preferably about 4 parts by weight or less and even more preferably about 3 parts by weight or less. Generally, the amount of cyclic silane are present such that the molecular ratio NCO/silane groups is from about 20/1 or 10/1 to about 1/1.

The isocyanate functional prepolymer is present in sufficient quantity to provide adhesive character to the adhesive composition. Such prepolymers have an average isocyanate functionality sufficient to allow the preparation of a crosslinked polyurethane upon cure and not so high that the polymers are unstable. “Stability” in this context means that the prepolymer or adhesive prepared from the prepolymer has a shelf life of at least four months at ambient temperatures, in that it does not demonstrate an increase in viscosity during such period which prevents its application or use. For example, the viscosity should not rise too greatly to make it impractical to pump the adhesive composition. Preferably, the prepolymer or adhesive prepared therefrom does not undergo an increase in viscosity of more than about 50 percent during the stated period.

The prepolymer preferably has a free isocyanate content which facilitates acceptable strength in adhesives prepared from the prepolymers after 60 minutes and stability of the prepolymer. Preferably, the free isocyanate content is about 0.6 percent by weight or greater based on the weight of the prepolymer and more preferably about 0.8 percent by weight or greater, and preferably about 5.0 percent by weight or less, more preferably about 3.5 or less, even more preferably about 3.0 percent by weight or less, and even more preferably about 2.6 percent by weight or less. Above about 5.0 percent by weight, the adhesives prepared from the prepolymer may demonstrate lap shear strengths after 60 minutes that may be too low for the intended use. Below about 0.8 percent by weight, the prepolymer viscosity may be too high to handle and the working time may be too short.

The prepolymer preferably exhibits a viscosity, which facilitates formulation of a pumpable adhesive which has good green strength. Preferably, the viscosity of the prepolymer is about 100,000 centipoise (100 Pa s) or less and more preferably about 50,000 centipoise (50 Pa s) or less, and most preferably about 30,000 centipoise (30 Pa s) or less and about 1,000 centipoise (1 Pa s) or greater. The viscosity of the adhesive can be adjusted with fillers, although the fillers generally do not improve the green strength of the final adhesive. Below about 1,000 centipoise (1 Pa s), the adhesive prepared from the prepolymer may exhibit poor green strength. Above about 100,000 centipoise (100 Pa s) the prepolymer may be unstable and hard to dispense. Prepolymer viscosity is measured using Brookfield viscometer at 20 rpm using a #6 spindle at 23° C.±2° C.

When making the isocyanate terminated prepolymer of this invention, the polyisocyanate generally has an isocyanate functionality of about 1.5 or 2 to about 3.5. It is understood that when referring to the isocyanate functionality, it is referring to the theoretical functionality, which can generally be calculated from the stoichiometry of the ingredients used, but the actual functionality may be different, for example, due to imperfections in raw materials, incomplete conversion of the reactants and formation of byproducts.

Any polyisocyanates that realizes the aforementioned functionality may be used. For example, the polyisocyanates may be any aliphatic, cycloaliphatic, araliphatic, heterocyclic or aromatic polyisocyanate, or mixtures thereof. Illustratively, the polyisocyanates may include those disclosed by Wu, U.S. Pat. No. 6,512,033 at column 3, line 3 to line 49. More preferred isocyanates are aromatic isocyanates, alicyclic isocyanates and derivatives thereof. Preferably, the aromatic isocyanates have the isocyanate groups bonded directly to aromatic rings. Preferably, the polyisocyanate is comprised of an oligomer of an aromatic or cycloaliphatic polyisocyanate such as diphenyl-methane-4,4′-diisocyanate (MDI), isophorone diisocyanate, tetramethylxylene diisocyanate or mixture thereof. Exemplary polyisocyanates include ISONATE 125M, ISONATE 50OP, PAPI 94 or PAPI 27 polyisocyanates available from The Dow Chemical Company, Midland, Mich.

Desirably, the equivalent weight of the polyisocyanate is at least about 80, more preferably at least about 110, and is most preferably at least about 120, and is preferably no greater than about 600, more preferably no greater than about 500, and most preferably no greater than about 300.

The amount of polyisocyanate used to prepare the prepolymer is that amount that gives the desired properties, that is, the appropriate free isocyanate content and viscosities as discussed herein. Preferably, the polyisocyanates are used to prepare in the prepolymer in an amount of about 1.1 equivalents of isocyanate (NCO) per equivalent of active hydrogen or greater, more preferably about 1.2 equivalents of isocyanate or greater and most preferably about 1.5 equivalents of isocyanate or greater. Preferably, the polyisocyanates used to prepare the prepolymer are used in an amount of about 2.2 equivalents of isocyanate or less, more preferably 2.0 equivalents of isocyanate or less and most preferably about 1.9 equivalents of isocyanate or less.

The isocyanate terminated prepolymers are made from active hydrogen compounds such as described by U.S. Pat. No. 5,922,809 at column 4, line 38 to column 5, line 50 and Wu, U.S. Pat. No. 6,512,033 at col. 3, line 57 to col. 4, line 64. Preferably the active hydrogen compounds are polyols. Exemplary polyols include polyester polyols, polyether polyols, poly(alkylene carbonate)polyols, hydroxyl containing polythioethers and mixtures thereof, which are also describe in the above cited references. The polyol (diols and triols) are preferably polyether polyols containing one or more alkylene oxide units in the backbone of the polyol. Preferred alkylene oxide units are ethylene oxide, propylene oxide, butylene oxide and mixtures thereof. Preferably, the polyol contains propylene oxide units, ethylene oxide units or a mixture thereof. The alkylene oxides can contain straight or branched chain alkylene units.

In an embodiment containing polyether polyols containing ethylene oxide (EO) and propylene oxide (PO) units, the ethylene oxide content in the prepolymer is typically about 5 to 80 percent by weight of the polyol. Desirably the EO content is 10% or 20% to 70%, 60% or 50% by weight of the polyol. When making the prepolymer with a polyether polyol a small amount of other polyols may be used to form the prepolymer such as a polyester polyol such as those known in the art. Typically, such other polyols may be present in an amount of about up to 5% by weight of the polyol used to make said prepolymer.

When the polyol is a polyether polyol, it may be random or a block polymer of differing polyether units. Desirably, the polyol is ethylene oxide-capped such as occurs when reacting glycerin with propylene oxide, followed by reacting the product with ethylene oxide (i.e., EO capped polyether polyol).

As per an embodiment, the polyol is comprised of a diol and triol. The diol has a weight average molecular weight (M_{w}) of 200 to 8000 grams. Preferably, the diol has an M_{w} of 500 to 4,000, or 1,000 to 3,000 or 1,500 to 2,500 grams/mole. The triol has an M_{w} of 100 to 10,000 grams/mole. Preferably, the triol has an M_{w} of 700 to 6,000 or 1,500 to 4,500 grams/mole. Desirably, the triol has an EO content is from about 5% to 60% by weight of the triol and preferably is from 10% or 15% to 50% or 30% of the triol by weight. Desirably, the diol has an EO content that is less than about 40%, 30%, 20%, 10%, 5% or even 0% by weight of the diol.

Exemplary polyols (diols and triols) include polyols available from The Dow Chemical Company, Midland, Mich. such as VORANOL™ 220-028, a 4000 molecular weight polyether diol, VORANOL™ 220-094, a propylene glycol initiated 1200 molecular weight homopolymer diol, VORANOL™ 220-110N, a propylene glycol initiated 1000 molecular weight homopolymer polyether diol, VORANOL™ 220-260, a 425 molecular weight homopolymer polyether diol, VORANOL™ 220-530, an amine initiated polyether polyol, VORANOL™ 221-050, a 2200 molecular weight diol, VORANOL™ 222-029, a 4000 molecular weight polyether diol based on propylene oxide with ethylene oxide capping, VORANOL™ 222-056, a 2000 molecular weight polyether diol based on propylene oxide with ethylene oxide capping, VORANOL™ 2070 is a glycerine initiated, 700 molecular weight, homopolymer triol polyol, VORANOL™ 225 is a 250 molecular weight glycerine-initiated polyether triol, VORANOL™ 230-056 is a glycerine-initiated homopolymer polyether triol with a nominal 3000 molecular weight, VORANOL™ is a polyether homopolymer triol with a nominal molecular weight of 1500, VORANOL™ 230-660 is a 250 molecular weight polyether triol, VORANOL™ 232-034 is an EO capped polyether triol with nominal molecular weight of 4800, VORANOL™ 232-035 is a nominal 5000 molecular weight, EO capped polyether triol. The aforementioned molecular weights are M_{w}.

The isocyanate prepolymer of the invention has an M_{w} between 10,000 to about 200,000 g/mole. The “molecular weight average” used herein is the weight average molecular weight (M_{w}) molecular weight average as defined on page 199 of Textbook of Polymer Science 3^{rd} Edition, Billmeyer, F. W. Jr., John Wiley and Sons, NY, N.Y., 1984. Desirably, the M_{w} average is at least in ascending desirability: 20,000, 30,000, 40,000, 50,000 and 55,000 to at most about 150,000 or even at most about 100,000.

The prepolymer may also contain reactive silicon within or pendant to the backbone of the prepolymer or as a terminal group in the prepolymer. The reactive silicon, is one that can undergo hydrolysis such as described at column 4, lines 25-55 of U.S. Pat. No. 6,613,816. Other illustrative reactive silicons may be found in U.S. Patent Publication 2002/0100550 paragraphs 0055 to 0065 and Hsieh, U.S. Pat. No. 6,015,475, column 5, line 27 to column 6, line 41, each incorporated herein by reference.

The isocyanate terminated prepolymer may be prepared by any suitable method, such as bulk polymerization and solution polymerization. Exemplary processes useful to make the prepolymers are disclosed in U.S. Pat. No. 5,922,809 at column 9, lines 4 to 51. The polyurethane prepolymers are present in the adhesive composition in an amount sufficient such that when the resulting adhesive cures, substrates are bound together. The reaction to prepare the prepolymer is carried out under anhydrous conditions, preferably under an inert atmosphere such as a nitrogen blanket and to prevent crosslinking of the isocyanate groups by atmospheric moisture. The reaction is preferably carried out at a temperature between about 0° C. and about 150° C., more preferably between about 25° C. and about 90° C., until the residual isocyanate content determined by titration of a sample is very close to the desired value. “Isocyanate content” means the weight percentage of isocyanate moieties to the total weight of the prepolymer.

The reactions to prepare the prepolymer may be carried out in the presence of urethane catalysts. Examples of such include the stannous salts of carboxylic acids, such as stannous octoate, stannous oleate, stannous acetate, and stannous laurate. Also, dialkyltin dicarboxylates such as dibutyltin dilaurate, dibutyltin diacetate, dimethyl tin dilaurate and dimethyltin diacetate are known in the art as urethane catalysts, as are tertiary amines such as triethyldiamine and tin mercaptides. Preferably, the reaction to prepare the prepolymer is catalyzed by stannous octoate. The amount of catalyst employed is generally between about 0.005 and about 5 parts by weight of the mixture catalyzed, depending on the nature of the isocyanate.

The prepolymer is typically present in an amount of about 20 parts by weight of the adhesive composition or greater, more preferably about 30 parts by weight or greater and most preferably about 35 parts by weight or greater. Preferably, the prepolymers are present in an amount of about 60 parts by weight of the adhesive composition or less, more preferably about 50 parts by weight or less and even more preferably about 45 parts by weight or less.

The filler is generally one that facilitates realizing the rheological properties desired such as pumpability, sag and string necessary particularly when the adhesive composition is used to install windows in vehicles and buildings. The filler may be any useful such as those known in the art and include, for example, carbon black, calcium carbonate, coal or fly ash, clays and other inorganic particulates. Any combination or mixture of fillers may be used.

Typically, the total amount of the filler is about 10% to 40% by weight of the adhesive. It is preferred that at least a portion of the filler is carbon black. The carbon blacks depending on their structure and the molecular weight of the prepolymers may range over a wide range of structures as given by oil absorption number (ASTM D-2414-09). For example, the carbon black typically should be an oil absorption number (OAN) of about 80 to 200 ccs per 100 grams. Preferably, the oil absorption of the carbon is at least about 90, more preferably at least about 100, and most preferably at least about 110 to preferably at most about 180, more preferably at most about 165 and most preferably at most about 150 cc s/100 grams.

In addition the carbon black desirably has an iodine number that is at least 80. The iodine number is related to the surface area of the carbon black, but also to the presence of volatile species such as unsaturated oils and, sulfur containing compounds. The iodine number is determined using ASTM D1510-11.

The amount of carbon black suitable may be determined for a given carbon black and by routine experimentation. Typically, the amount of carbon black is at least in ascending desirability, 5%, 10%, 15%, 18% or 23% to at most, in ascending desirability, 32%, 30% or 28% by weight of the adhesive composition.

The carbon black used in this invention may be a standard carbon black which is not specially treated to render it nonconductive. Standard carbon black is carbon black which is not specifically surface treated or oxidized. Alternatively, one or more nonconductive carbon blacks may be used exclusively or in conjunction with the standard carbon black. Suitable standard carbon blacks include Monarch 5700, Monarch 580, Elftex 5100 or Elftex 7100 carbon blacks available from Cabot Corporation, Arosperse 11 carbon black available from Colombian Chemicals Company, Centerville, La., and PRINTEX™ 30 carbon black available from Evonik Industries, Mobile, Ala. Suitable non-conductive carbon blacks include RAVEN™ 1040 and RAVEN™ 1060 carbon black available from Colombian Chemicals Co.

The adhesive also contains a catalyst which catalyzes the reaction of isocyanate moieties with water or an active hydrogen containing compound and include those already described above in making the prepolymer. The catalyst may be any catalyst known to the skilled artisan for the reaction of isocyanate moieties with water or active hydrogen containing compounds. Preferred catalysts include organotin compounds, metal alkanoates, and tertiary amines Mixtures of classes of catalysts may be used. A mixture of a tertiary amine and a metal salt is desirable. Tertiary amines, such as dimorpholino diethyl ether (DMDEE), and a metal alkanoate, such as bismuth octoate are a preferred catalyst mixture. Included in the useful catalysts are organotin compounds such as alkyl tin oxides, stannous alkanoates, dialkyl tin carboxylates and tin mercaptides. Stannous alkanoates include stannous octoate. Alkyl tin oxides include dialkyl tin oxides, such as dibutyl tin oxide and its derivatives. The organotin catalyst is preferably a dialkyltin dicarboxylate or a dialkyltin dimercaptide. Dialkyl tin dicarboxylates with lower total carbon atoms are preferred as they are more active catalysts in the compositions of the invention. The preferred dialkyl dicarboxylates include 1,1-dimethyltin dilaurate, 1,1-dibutyltin diacetate and 1,1-dimethyl dimaleate. Preferred metal alkanoates include bismuth octoate or bismuth neodecanoate. If the organo tin or metal alkanoate catalyst is present, it typically is present in an amount of about 60 parts per million or greater based on the weight of the adhesive, more preferably 120 parts by million or greater. The total amount of catalysts in the adhesive composition is generally at most about 5%, 2% or 1% to at least about 0.01%, 0.1% or 0.4% by weight of the adhesive composition.

Useful tertiary amine catalysts include dimorpholinodialkyl ether, a di((dialkylmorpholino)alkyl) ether, bis-(2-dimethylaminoethyl)ether, triethylene diamine, pentamethyldiethylene triamine, N,N-dimethylcyclohexylamine, N,N-dimethyl piperazine 4-methoxyethyl morpholine, N-methylmorpholine, N-ethyl morpholine and mixtures thereof. A preferred dimorpholinodialkyl ether is dimorpholinodiethyl ether. A preferred di((dialkylmorpholino)alkyl) ether is (di-(2-(3,5-dimethyl-morpholino)ethyl)-ether). Tertiary amines are preferably employed in an amount, based on the weight of the adhesive of about 0.01 percent by weight or greater, more preferably about 0.05 percent by weight or greater, even more preferably about 0.1 percent by weight or greater and most preferably about 0.2 percent by weight or greater and about 2.0 percent by weight or less, more preferably about 1.75 percent by weight or less, even more preferably about 1.0 percent by weight or less and most preferably about 0.4 percent by weight or less.

Surprisingly the adhesive composition comprised of the cyclic silane may improve the bonding to press bent glass fits even without using a primer. Other adhesion promoters and primers such as those known in the art, of course, may be used, for example, to further improve the adhesion.

The adhesion composition may also contain a plasticizer. The plasticizer should be free of water, inert to isocyanate groups and compatible with the prepolymer and reactive plasticizer. Such material may be added to the reaction mixtures for preparing the prepolymer, or to the mixture for preparing the final adhesive composition, but is preferably added to the reaction mixtures for preparing the prepolymer, so that such mixtures may be more easily mixed and handled. Suitable plasticizers are well known in the art and include straight and branched alkyl phthalates, such as diisononyl phthalate, dioctyl phthalate and dibutyl phthalate, a partially hydrogenated terpene commercially available as “HB-40” and castor oil.

Other plasticizers include one or more of alkyl esters of sulfonic acid, alkyl alkylethers diesters, polyester resins, polyglycol diesters, polymeric polyesters, tricarboxylic esters, dialkylether diesters, dialkylether aromatic esters, aromatic phosphate esters, aromatic sulfonamides and alkyl esters of natural oils such as soy, castor, sunflower, linseed and corn or alkyl esters of their individual fatty acids such as palmitic, oleic and linoleic. More preferred high polar plasticizers include aromatic sulfonamides, aromatic phosphate esters, dialkyl ether aromatic esters and alkyl esters of sulfonic acid. Most preferred plasticizers include alkyl esters of sulfonic acid and toluene-sulfamide. Alkyl esters of sulfonic acid include alkylsulphonic phenyl ester available from Lanxess under the trademark MESAMOLL. Aromatic phosphate esters include PHOSFLEX™ 31 L isopropylated triphenyl phosphate ester, DISFLAMOLL™ DPO diphenyl-2-ethyl hexyl phosphate, and DISFLAMOL™ TKP tricresyl phosphate. Dialkylether aromatic esters include BENZOFLEX™ 2-45 diethylene glycol dibenzoate. Aromatic sulfonamides include KETJENFLEX™ 8 o and p, N-ethyl toluenesulfonamide Vegetable based plasticizers may also be used, including alkyl esters of soy such as available under the tradename SOYGOLD 1000™, COLUMBUS 970 or Gold 4EG or canola oil, Columbus 973.

The adhesive may further comprise a free polyfunctional isocyanate, for example, which may improve the modulus of the composition in the cured form or adhesion of the adhesion composition to particular substrates such as painted substrates. “Polyfunctional” as used in the context of the isocyanates refers to isocyanates having a functionality of 2 or greater. The polyisocyanates can be any monomeric, oligomeric or polymeric isocyanate having a nominal functionality of about 2.5 or greater. More preferably, the polyfunctional isocyanate has a nominal functionality of about 3 or greater. Preferably, the polyfunctional isocyanate has a nominal functionality of about 5 or less, even more preferably about 4.5 or less and most preferably about 3.5 or less. The polyfunctional isocyanate can be any isocyanate which is reactive with the isocyanate polyisocyanate prepolymers used in the composition and which improves the modulus of the cured composition. The polyisocyanates can be monomeric; trimeric isocyanurates or biurets of monomeric isocyanates; oligomeric or polymeric, the reaction product of several units of one or more monomeric isocyanates. Examples of preferred polyfunctional isocyanates include trimers of hexamethylene diisocyanate, such as those available from Bayer AG under the trademark and designation DESMODUR N3300, and polymeric isocyanates such as polymeric MDI (methylene diphenyl diisocyanates) such as those marketed by The Dow Chemical Company under the trademark of ISONATE or PAPI, including PAPI 20, PAPI 580N, PAPI 94 or PAPI 27 polymeric isocyanates.

The polyfunctional isocyanates, when present are typically present in an amount sufficient to impact the modulus of the cured compositions of the invention or improve the adhesion to certain substrates described above. The polyfunctional isocyanate, when present, is preferably present in an amount of about 0.5 parts by weight or greater based on the weight of the adhesive composition, more preferably about 1.0 parts by weight or greater and most preferably about 2 parts by weight or greater. The polyfunctional isocyanate is preferably present in an amount of about 8 parts by weight or less, based on the weight of the adhesive composition, more preferably about 5 parts by weight or less and most preferably about 4 parts by weight or less.

The adhesive may further comprise stabilizers, which function to protect the adhesive from moisture, thereby inhibiting advancement and preventing premature crosslinking of the isocyanates in the adhesive composition. Stabilizers known to the skilled artisan for moisture curing adhesives may be used. Included among such stabilizers are diethylmalonate, alkylphenol alkylates, paratoluene sulfonic isocyanates, benzoyl chloride and orthoalkyl formates. However, it has been surprisingly discovered that the adhesive containing the reactive plasticizer, generally should have lower amounts than adhesives made solely using a nonreactive plasticizer. For example, it is generally preferred that at most 0.2 part by weight of such stabilizers are used and more preferably at most about 0.02 parts or even no stabilizers such as diethylmalonate is present. If too much stabilizer is present, the adhesive may take too long to cure or may not cure adequately.

The adhesive may further comprise a hydrophilic material that functions to draw atmospheric moisture into the composition. This material enhances the cure speed of the formulation by drawing atmospheric moisture to the composition. Preferably, the hydrophilic material is a liquid. Among preferred hydroscopic materials are pyrolidinones such as 1 methyl-2-pyrolidinone, available from under the trademark M-PYROL. The hydrophilic material is preferably present in an amount of about 0.1 parts by weight or greater and more preferably about 0.3 parts by weight or greater and preferably about 1.0 parts by weight or less and most preferably about 0.6 parts by weight or less. Optionally, the adhesive composition may further comprise a thixotrope. Such thixotropes are well known to those skilled in the art and include alumina, limestone, talc, zinc oxides, sulfur oxides, calcium carbonate, perlite, slate flour, salt (NaCl), cyclodextrin, amorphous solid polyester and the like. The thixotrope may be added to the adhesive of a composition in a sufficient amount to give the desired rheological properties. Preferably, the thixotrope is present in an amount of about 0.01 parts by weight or greater based on the weight of the adhesive composition, preferably about 2 part by weight or greater.

Other components commonly used in such adhesives may be used. Such materials include those known in the art and may include ultraviolet stabilizers and antioxidants and the like.

As used herein, all parts by weight relative to the components of the adhesive are based on 100 total parts by weight of the adhesive.

The adhesive may be formulated by blending the components together using means well known in the art. Generally, the components are blended in a suitable mixer. Such blending is preferably conducted in an inert atmosphere in the absence of oxygen and atmospheric moisture to prevent premature reaction. As appropriate, depending the components to be blended, the adhesive composition may be blended at an elevated temperature, for example, to melt components that may be solid at room temperature. For example, the temperatures utilized are typically room temperature or from about 40° C. to less than about 90° C. and more preferably about 50° C. to about 70° C. It may be advantageous to add any plasticizers, if desired, to the reaction mixture for preparing the isocyanate terminated prepolymer so that such mixture may be easily mixed and handled. Alternatively, the plasticizers can be added during blending of all the components. Once the adhesive is formulated, it is packaged in a suitable container such that it is protected from atmospheric moisture and oxygen. Contact with atmospheric moisture and oxygen could result in premature crosslinking of the polyurethane prepolymer-containing isocyanate groups.

The adhesive may be used to bond a variety of substrates together as described hereinbefore. The composition can be used to bond porous and nonporous substrates together. The adhesive composition is applied to a substrate and the adhesive on the first substrate is thereafter contacted with a second substrate. In preferred embodiments, the surfaces to which the adhesive is applied are cleaned and primed prior to application, see for example, U.S. Pat. Nos. 4,525,511; 3,707,521 and 3,779,794; relevant parts of all are incorporated herein by reference. Generally, the adhesives of the invention are applied at ambient temperature in the presence of atmospheric moisture. Exposure to atmospheric moisture is sufficient to result in curing of the adhesive. Curing can be accelerated by the addition of additional water or by applying heat to the curing adhesive by means of convection heat, microwave heating and the like. Preferably, the adhesive is formulated to provide a working time of about 6 minutes or greater, and more preferably about 12 minutes or greater. Preferably, the working time is about 60 minutes or less and more preferably about 30 minutes or less.

The adhesive is preferably used to bond glass or plastic coated with an abrasion resistant coating, to other substrates such as bare or painted metals or plastics. In a preferred embodiment, the first substrate is a glass, or plastic coated with an abrasion resistant coating, and the second substrate is a window frame. In another preferred embodiment, the first substrate is a glass, or plastic coated with an abrasion resistant coating, and the second substrate is a window frame of an automobile. Preferably, the glass window is cleaned and has a glass primer applied to the area to which the adhesive is to be bonded. The plastic coated with an abrasion resistant coating can be any plastic which is clear, such as polycarbonate, acrylics, hydrogenated polystyrene or hydrogenated styrene conjugated diene block copolymers having greater than 50 percent styrene content. The coating can comprise any coating which is abrasion resistant such as a polysiloxane coating. Preferably, the coating has an ultraviolet pigmented light blocking additive. Preferably, the glass or plastic window has an opaque coating disposed in the region to be contacted with the adhesive to block UV light from reaching the adhesive.

In an embodiment, the adhesive is used to replace windows in structures or vehicles and most preferably in vehicles. The first step is removal of the previous window. This can be achieved by cutting the bead of the adhesive holding the old window in place and then removing the old window. Thereafter the new window is cleaned and may be primed. The old adhesive that is located on the window flange can be removed, although it is not necessary and in most cases it is left in place. The window flange is typically primed with a paint primer. The adhesive is applied in a bead to the periphery of the window where a fused enamel (i.e., press or sag bent glass frit) is located such that it will contact the window flange when placed in the vehicle. Preferably, the window is a press bent glass window. The window with the adhesive located thereon is then placed into the flange with the adhesive located between the window and the flange. The adhesive bead is a continuous bead that functions to seal the junction between the window and the window flange. A continuous bead of adhesive is a bead that is located such that the bead connects at each end to form a continuous seal between the window and the flange when contacted. Thereafter the adhesive is allowed to cure.

In another embodiment, the compositions of the invention can be used to bond modular components together. Examples of modular components include vehicle modules, such as door, window or body.

### Testing and Analytical Procedures

Peel testing was conducted to determine the adhesion strength between glass frits and the adhesives. An electromechanical load frame (Instron 5566) was used with a 90°-peel test fixture. The stroke rate was kept as 10 mm/min Bluehill 2.0 software was used for data acquisition. All tests were conducted at room temperature. The peel force obtained in this experiment was divided by the width of the frit to determine the peel strength. In addition to calculating the peel strength values, each tested specimen was inspected to determine the mode of failure (adhesive or cohesive). Adhesive failure (AF) is characterized by the adhesive peeling cleanly away from the frit, indicating failure at the bonding surface. Cohesive failure is characterized by a residue being left behind, indicating that failure occurred within the bulk of the adhesive. Cohesive failure (CF) is the desired result.

### Illustrative Embodiments of the Invention

The following examples are provided to illustrate the invention, but are not intended to limit the scope thereof. All parts and percentages are by weight unless otherwise indicated. Table 1 shows the materials used.

### Materials:

The press bent frit glass used was a glass obtained from CAT I Glass Manufacturing, South Elgin, Ill. having a press bent glass frit AD3402 (available Ferro Corp., Mayfield Heights, Ohio). The sag bent frit glass used was a glass obtained from CAT I Glass Manufacturing having sag bent glass frit 2L5350 (available from Johnson Matthey Inc., Taylor, Mich.). Prior to application of the adhesives, the frit was lightly abraded with a SCOTCH-BRITE abrasive pad (3M, Minneapolis, Minn.) and any loose particles were blown off. Further materials used are shown in Table 1.

TABLE 1
Raw Materials

| Component | Description | Supplier |
|---|---|---|
| Palatinol N | diisononylphthalate (DINP) | BASF |
| | | Corporation |
| | | North America |
| MPTS | 3-mercaptopropyl)trimethoxysilane | Sigma Aldrich |
| APTS | 3-aminopropyl)trimethoxysilane | Sigma Aldrich |
| N—Me- | N-methyl(3-aminopropyl)trimethoxysilane | Sigma Aldrich |
| APTS | | |
| TSPU | 1-(3-(trimethoxysilyl)propyl)urea | Sigma Aldrich |
| IPTS | 3-isocyanatopropyl)triethoxysilane | Sigma Aldrich |
| GPTS | 3-glycidyloxypropyl)trimethoxysilane | Sigma Aldrich |
| DTSCP | dimethoxythiosilacyclopentane | Sigma Aldrich |
| N—Bu- | N-butyl)aminodimethoxysilacyclopentane | Sigma Aldrich |
| ADSCP | | |
| Elftex S | carbon black | Cabot |
| S7100 | | Corporation |
| DMDEE | 2,2′-dimorpholinodiethylether | Huntsman |
| | | Corporation |

### Prepolymer Preparation

A MDI-functional prepolymer had 1.52 wt % NCO content and was prepared in the same manner as Comparative Example 6 in U.S. Pat. No. 8,729,168.

### Adhesive Preparation

Comparative Example 1 was prepared using a high speed mixer (a product of FlackTek, Inc.). The prepolymer (40.0 g) was weighed into a 100 g speed mixer container. Carbon black (13.0 g) was added and the material was mixed at 2350 rpm for 3 minutes. The sides and bottom of the container were scraped and the material was mixed at 2350 rpm for a further 2 minutes. The sides and bottom were scraped down again. The Palatinol N (1.33 g) and Jeffcat DMDEE (0.200 g) were added. The material was blanketed with nitrogen and mixed at 2100 rpm for 2 minutes. The material was then applied to frit surfaces using a wooden tongue depressor.

Samples were allowed to cure for 1 week at 25° C. and 50% relative humidity before testing by 90° peel test. Values reported for room temperature experiments are the average values of three replicate experiments.

TABLE 2
Control Adhesive Preparation Composition.

| Material | Trade name | Ratio | Amt (g) | wt % |
|---|---|---|---|---|
| Prepolymer | | 30 | 40.00 | 73.3 |
| DMDEE | Jeffcat DMDEE | 0.15 | 0.20 | 0.4 |
| Carbon black | | 9.75 | 13.00 | 23.8 |
| Pal N | Palatinol N | 1 | 1.33 | 2.4 |
| total: | | 40.9 | 54.53 | 100.00 |

The control adhesive was applied to the press bent glass and sag bent glass and tested as described above. The testing results are shown in Table 3.

### Example 1

To the Comparative Example 1 adhesive (control adhesive), an amount of (N-butyl)aminodimethoxysilacyclopentane (N-Bu-ADSCP) cyclic silane is added to the Adhesive prior to the final mixing period in an amount such that there is a 4/1 ratio of NCO/Si in N-Bu-ADSCP. The N-Bu-ADSCP is the last ingredient added when forming the adhesive as described above. The testing results are shown in Table 3.

### Example 2

To the Comparative Example 1 adhesive, an amount of dimethoxythio-silacyclopentane (DTSCP) cyclic silane is added to the adhesive prior to the final mixing period in an amount such that there is a 4/1 ratio of NCO/Si in the DTSCP in the same manner as in Example 1. The testing results are shown in Table 3.

### Comparative Examples 2-5

To the Comparative Example 1 adhesive, the following silane adhesion promoters, Comparative Example 2: (3-mercaptopropyl)trimethoxysilane (MPTS), Comparative Example 3: (3-aminopropyl)trimethoxysilane (APTS), Comparative Example 4: N-methyl(3-aminopropyl)trimethoxysilane (N-Me-APTS) and Comparative Example 5: 1-(3-(trimethoxysilyl)propyl)urea (TSPU), were added in the same manner and at the same NCO/Si ratio as described for Example 1. The testing results are shown in Table 3.

From Table 3, the cyclic silane adhesion promoters display superior peel strength compared to the non-cyclic silane adhesion promoters, particularly for sag bent frits. Likewise, they also display the best peel strength for press bent glass frits other than Comparative Example 5, which has a slightly higher strength, but is utterly inadequate for sag bent frits. This demonstrates the robustness of the cyclic silane adhesion promoters being applicable to various substrates making them far superior in environments where multiple differing substrates may be used.

TABLE 3

| | | Press | Press | Sag Bent | |
|---|---|---|---|---|---|
| | Silane | Bent Peel | Bent | Peel | Sag Bent |
| | Adhesion | Strength | Failure | Strength | Failure |
| Example | Promoter | (N/cm) | Mode | (N/cm) | Mode |
| 1 | N—Bu ADSCP | 23.6 | AF | 102.0 | CF |
| 2 | DTSCP | 29.4 | AF | 126.9 | CF |
| Comp. 1 | None | 17.1 | AF | 42.7 | AF |
| Comp. 2 | MPTS | 12.0 | AF | 12.0 | AF |
| Comp. 3 | APTS | 10.8 | AF | 16.7 | AF |
| Comp. 4 | N—Me-APTS | 16.9 | AF | 59.7 | AF |
| Comp. 5 | TPSU | 33.1 | AF | 33.1 | AF |
| Comp. 6 | IPTS | 8.5 | AF | 7.8 | AF |
| Comp. 7 | GPTS | 19.7 | AF | 18.5 | AF |

### Example 3

Example 2 was repeated except that the amount DTSCP used resulted in a 10/1 ratio of NCO/silane groups. The peel strength on the press bent and sag bent frit was 35.1 N/cm and 126.1 N/cm respectively. The failure mode of the adhesive was adhesive failure. This example shows that at even low concentrations the DTSCP can display superior peel strength compared to other silane adhesion promoters that are not cyclic.

### Example 4

Example 2 was repeated except that the amount of DTSCP used resulted in a 10/9 ratio of NCO/silane groups. The peel strength on the press bent and sag bent frit was 57.1.1 N/cm and 69.3 N/cm respectively. The failure mode of the adhesive was cohesive failure. This Example shows that DTSCP has the ability to be used for both sag and press bent glass frits and realizes the desired cohesive failure mode.

1. A one part moisture curable adhesive composition comprising, (a) an isocyanate functional prepolymer, (b) a cyclic silane, (c) a filler and (d) a catalyst.

2. The adhesive composition of claim 1, wherein the cyclic silane is comprised of: 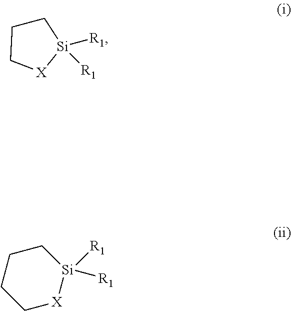
or mixture of (i) and (ii),
where X is a O, S, or N—R₂, where R₂ is a C₁-C₁₂ alkyl, alkylaryl or aryl, and R₁ is independently C₁-C₁₂ alkyl, C₁-C₁₂ alkoxy or C₁-C₁₂ acyloxy so long at least one R₁ is C₁-C₁₂ alkoxy or C₁-C₁₂ acyloxy.

3. The adhesive composition of claim 2, wherein each R₁ is C₁-C₁₂ alkoxy or C₁-C₁₂ acyloxy.

4. The adhesive composition of claim 3, wherein each R₁ is C₁-C₁₂ alkoxy.

5. The adhesive composition of claim 4, wherein each R₁ is C₁-C₃ alkoxy.

6. The adhesive composition of claim 5, wherein each X is S or N—R₂.

7. The adhesive composition of claim 2, wherein cyclic silane is (i).

8. The adhesive composition of claim 7, wherein X is S, N—R₂ and each R₁ is C₁-C₁₂ alkoxy.

9. The adhesive composition of claim 8, wherein R₁ is C₁-C₃ alkoxy.

10. The adhesive composition of claim 1, wherein the isocyanate functional prepolymer has a polymer backbone comprised of a polyether, polyester or combination thereof.

11. The adhesive composition of claim 10, wherein the backbone is the polyether.

12. The adhesive composition of claim 11, wherein the polyether is comprised alkylene oxide units.

13. The adhesive composition of claim 12, wherein the alkylene oxide units are ethylene oxide, propylene oxide or mixture thereof.

14. The adhesive composition of claim 10, wherein the backbone is further comprised of hydrolyzable silane moities.

15. The adhesive composition of claim 1, wherein the isocyanate functional prepolymer has an isocyanate content of 0.8% to 5% by weight of said prepolymer.

16. The adhesive composition of claim 1, wherein the isocyanate functional prepolymer is comprised of the reaction product of a polyol and an isocyanate having an average isocyanate functionality greater than 1.5 to 3.

17. The adhesive composition of claim 16, wherein the polyether polyol has an average functionality of about 2 to about 3.5.

18. The adhesive composition of claim 12, wherein the prepolymer has a weight average molecular weight (M_{w}) of 2000 to about 200,000 g/mole.

19. The adhesive composition of claim 15, wherein the cyclic silane is present in an amount such that a molecular ratio of NCO/silane groups is from 20/1 to 1/1.

20. A method of bonding at least two substrates together comprising;
(i) delivering the adhesive composition of claim 1 to an application nozzle,
(ii) applying a bead of the adhesive composition from step (i) through the application nozzle on to at least a portion of at least one of the substrates,
(iii) contacting the substrates to be bonded and
(iv) allowing the adhesive composition to cure.
